(19) United States
(12) Patent Application Publication
(10) Pub. No.: US 2011/0058195 A1
(43) Pub. Date: Mar. 10, 2011

(54) COLOR INFORMATION PROCESSING APPARATUS AND RECORDING MEDIUM

(75) Inventor: Kyoko KANO, Ashigarakami-gun (JP)

(73) Assignee: FUJIFILM CORPORATION, Tokyo (JP)

(21) Appl. No.: 12/877,536

(22) Filed: Sep. 8, 2010

(30) Foreign Application Priority Data
Sep. 10, 2009 (JP) 2009-209666

(51) Int. Cl. H04N 1/60

(52) U.S. Cl. 358/1.9

(57) ABSTRACT

A color information processing apparatus includes a color information processor for carrying out a plurality of steps of approximating or matching a color that actually is printed by a printing apparatus to a designated color, a result display controller for displaying a result of each of the steps each time that the steps are carried out, and a color history display controller for displaying a plurality of colors acquired in the steps as a history of changing designated colors.

### CROSS-REFERENCE TO RELATED APPLICATION

This application is based upon and claims the benefit of priority from Japanese Patent Application No. 2009-209666 filed on Sep. 10, 2009, of which the contents are incorporated herein by reference.

### BACKGROUND OF THE INVENTION

1. Field of the Invention

The present invention relates to a color information processing apparatus and a recording medium for approximating or matching a color to be printed to a designated color.

2. Description of the Related Art

There has heretofore been developed a technology for approximating or matching a color, which actually is printed by a printing apparatus, to a designated color designated by the user by performing a plurality of processes to repeatedly generate and print a print sample (color chart), including a plurality of color patches that represent slightly different colors around color values of the designated color, thereby equalizing the color that actually is printed to the designated color (see Japanese Laid-Open Patent Publication No. 2000-217007).

The process of attempting to match a printed color to a designated color usually is repeated many times in order to equalize the printed color to the designated color, since it is unlikely for the printed color to be equalized to the designated color in one process. However, since the process is repeated many times, the user is unaware of how the printed color is being equalized to the designated color, and the user finds it difficult to recognize when and how the color has changed. If the designated color does not fall within a range of the gamut of the printing apparatus, then the designated color has to be mapped to the range of the gamut. In this case, the user is left uncertain concerning whether the mapping process has been carried out incorrectly, or if selection of the color was inappropriate.

### SUMMARY OF THE INVENTION

An object of the present invention is to provide a color information processing apparatus and a recording medium, which are capable of easily recognizing a color change during a color equalizing process for approximating or matching a color to be printed to a designated color.

To achieve the above object, there is provided in accordance with the present invention a color information processing apparatus comprising a color information processor for carrying out a plurality of steps of approximating or matching a color that actually is printed by a printing apparatus to a designated color, a result display controller for displaying a result of each of the steps each time that the steps are carried out, and a color history display controller for displaying a plurality of colors acquired in the steps as a history of changing designated colors.

The color information processing apparatus may further comprise a selector, which enables a user to select one of the colors displayed by the color history display controller, such that when the user selects one of the colors through the selector, the color information processor goes back to one of the steps which can change the selected color, and carries out again the steps from the one of the steps.

The steps carried out by the color information processor may include a step of acquiring the designated color, a step of, if the designated color falls outside of a range of a gamut of the printing apparatus, mapping the designated color to a range of the gamut so as to acquire the designated color, a step of generating image data of a first color chart including a plurality of color patches having different lightness values and chromaticity values within a color space around a reference color, the mapped designated color being set as the reference color if the designated color falls outside of the range of the gamut, and the designated color being set as the reference color if the designated color falls within the range of the gamut, and a step of colorimetrically measuring the first color chart, which is printed by the printing apparatus based on the image data, thereby acquiring the reference color that is printed together with a first color selected by a user, wherein the color history display controller displays as the history of changing designated colors the designated color, the reference color, the reference color that is measured colorimetrically, and the first color.

The color information processing apparatus may further comprise a color difference calculator for calculating a color difference between a given color and at least one color other than the given color, among the colors displayed by the color history display controller, wherein the color history display controller displays the color difference calculated by the color difference calculator.

The color difference calculator may calculate a color difference between the designated color and the reference color that is printed, and a color difference between the designated color and the first color if the designated color falls within the range of the gamut. Further, the color history display controller may display the color difference between the designated color and the reference color that is printed, and the color difference between the designated color and the first color.

The step of mapping the designated color to the range of the gamut in order to acquire the designated color may acquire a plurality of designated colors by mapping the designated color to the range of the gamut according to a plurality of mapping techniques. Further, the step of generating image data of a first color chart may generate image data of a first color chart including a plurality of color patches having different lightness values and chromaticity values within a color space around a reference color, wherein the designated color that is mapped according to one of the mapping techniques, which is selected by the user, is set as the reference color.

The result display controller may, as a result of the step of mapping the designated color to the range of the gamut, simultaneously display the designated colors mapped according to the mapping techniques and the acquired designated colors in adjacent positions.

The result display controller may, as a result of the step of mapping the designated color to the range of the gamut, display color values of the designated colors mapped according to the mapping techniques on coordinates.

The steps carried out by the color information processor may further include a step of adjusting the mapped designated color that is set as the reference color, wherein the step of generating image data of a first color chart may generate image data of a first color chart including a plurality of color patches having different lightness values and chromaticity values within a color space around the reference color, which is adjusted if the designated color falls outside of the range of the gamut, and wherein the color history display controller may display the reference color that is adjusted.

The steps carried out by the color information processor may further include a step of generating image data of a second color chart including the color patches at different color temperatures of light sources around the first color as a color under a light source having a reference color temperature, and a step of acquiring a second color selected by the user by colorimetrically measuring the second color chart that is printed by the printing apparatus based on the image data, wherein the color history display controller may display the second color.

To achieve the above object, there also is provided in accordance with the present invention a recording medium storing a program for enabling a computer to function as a color information processor for carrying out a plurality of steps for approximating or matching a color that actually is printed by a printing apparatus to a designated color, a result display controller for displaying a result of each of the steps each time that the steps are carried out, and a color history display controller for displaying a plurality of colors acquired in the steps as a history of changing designated colors.

Since the result produced when each of the steps is carried out is displayed each time that the step is carried out, the user can confirm the result of each step. Further, since a plurality of colors acquired by a plurality of steps are displayed as a history of changing designated colors, the user can recognize how the colors have changed, and can also recognize at a glance any step to be carried out again by viewing the history of changing designated colors.

The above and other objects, features, and advantages of the present invention will become more apparent from the following description when taken in conjunction with the accompanying drawings in which preferred embodiments of the present invention is shown by way of illustrative example.

### BRIEF DESCRIPTION OF THE DRAWINGS

FIG. 1 is a perspective view of a print processing system incorporating a color information processing apparatus according to an embodiment of the present invention;

FIG. 2 is an electric block diagram of the print processing system shown in FIG. 1;

FIG. 3 is a diagram illustrating the concept of a mapping process;

FIGS. 4 and 5 are flowcharts of an operation sequence of the print processing system shown in FIG. 1;

FIG. 6 is a view showing by way of example an image displayed by a result display controller shown in FIG. 2;

FIG. 7 is a view showing by way of example a color chart, which is displayed and printed;

FIG. 8 is a diagram showing a displayed image, representing a displayed history of changing designated colors;

FIG. 9 is a view showing an image that is displayed when control goes back to steps corresponding to selected colors; and

FIG. 10 is a diagram showing a displayed image, representing a displayed history of changing designated colors.

### DESCRIPTION OF THE PREFERRED EMBODIMENTS

A color information processing apparatus and a program for enabling a computer to function as a color information processing apparatus according to a preferred embodiment of the present invention will be described in detail below with reference to the accompanying drawings.

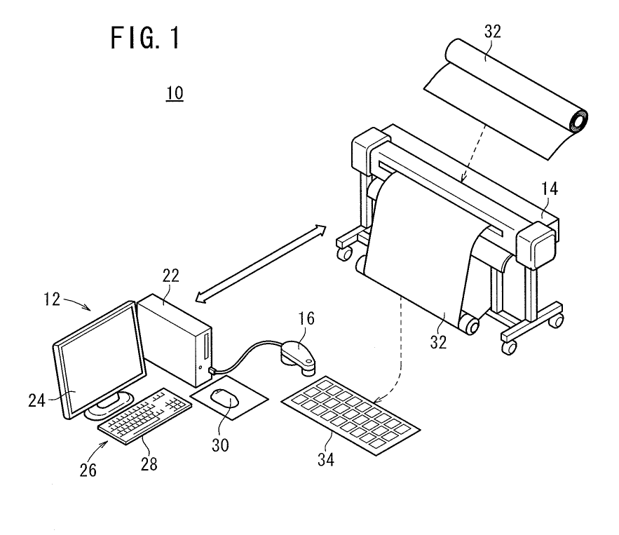

FIG. 1 shows in perspective a print processing system 10 incorporating a color information processing apparatus 12 according to an embodiment of the present invention. As shown in FIG. 1, the print processing system 10 includes, in addition to the color information processing apparatus 12, a printing apparatus 14 and a colorimeter 16.

The color information processing apparatus 12 serves to map color values that lie outside of the range of a gamut to color values within the range of the gamut, while also performing a color converting process. The color converting process is a process for converting colors that are not dependent on devices (device-independent colors) into colors that are dependent on devices (device-dependent colors). Device-independent colors are colors that cannot be printed by the printing apparatus 14, or colors that cannot be displayed by a display unit 24 of the color information processing apparatus 12. Device-dependent colors are colors that can be printed by the printing apparatus 14, or colors that can be displayed by the display unit 24. The color information processing apparatus 12 comprises a main unit having a CPU, a DSP, a memory, etc., the display unit 24 for displaying color images, and an operating device 26 including a keyboard 28 and a mouse 30.

The printing apparatus 14 comprises an inkjet printing apparatus for producing a color image based on a combination of basic inks made up of colors C, M, Y, K, and optional inks of light colors such as LC, LM, etc., and W (white). The printing apparatus 14 may comprise a TA printer, a thermal transfer printer, a dry-type electrophotographic printer, a tandem printer, a 4-cycle printer, or the like.

The printing apparatus 14 controls propulsion of inks onto a print medium 32 based on a print control signal received from the color information processing apparatus 12, which instructs the printing apparatus 14 to print a color image on the print medium 32, thereby producing a print 34. The print 34 shown in FIG. 1 comprises a color chart, including a plurality of color patches.

The colorimeter 16 acquires color values of a designated color by measuring a color sample or the like of the designated color, which has been prepared by the user of the print processing system 10. Such color values refer not only to the coordinates of a uniform color space, tristimulus values, etc., but also to a distribution of optical physical values with respect to wavelengths, e.g. spectral intensity, spectral reflectivity, or spectral transmittance. In the illustrated embodiment, the colorimeter 16 acquires color values in a color space represented by a CIEL*a*b* color system.

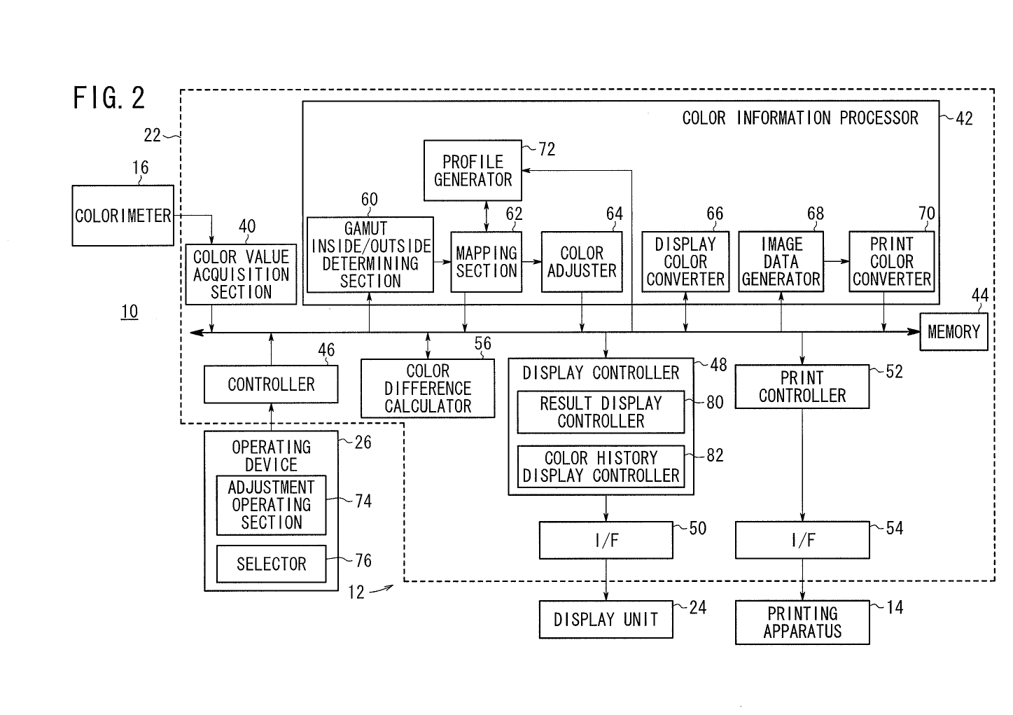

FIG. 2 is an electric block diagram of the print processing system 10. The main unit 22 comprises a color value acquisition section 40, a color information processor 42, a memory 44, a controller 46, a display controller 48, an I/F 50, a print controller 52, another I/F 54, and a color difference calculator 56. The controller 46 may comprise a processor such as CPU. The controller 46 controls various components of the main unit 22, including the color information processor 42, the print controller 52, etc. The memory 44 stores programs and data therein required for the controller 46 to control various components of the main unit 22, and a color table of colors depending on color values. The memory 44 also stores therein data required in a processing sequence of the color information processor 42. The memory 44 may comprise a recording medium such as a nonvolatile memory, a hard disk, or the like.

The operating device 26 outputs an operation signal to the controller 46 depending on an input action made by the user on the operating device 26. The controller 46 performs control operations depending on operation signals sent from the operating device 26. The operating device 26 includes an adjustment operating section 74 and a selector 76. The adjustment operating section 74 and the selector 76 are implemented by the keyboard 28 and/or the mouse 30.

The display controller 48 comprises a control circuit for controlling the display unit 24 under the control of the controller 46. More specifically, the display controller 48 outputs a display control signal via the I/F 50 to the display unit 24, thus energizing the display unit 24 to display an image thereon. The display controller 48 comprises a result display controller 80 and a color history display controller 82. The result display controller 80 displays on the display unit 24 the result of each of a plurality of steps of approximating or matching a color that actually is printed by the printing apparatus 14 to a designated color, each time the step is executed by the color information processor 42. The color history display controller 82 displays on the display unit 24 a plurality of colors acquired in the above steps as a history of changing designated colors.

The print controller 52 comprises a control circuit for controlling the printing apparatus 14 under the control of the controller 46. More specifically, the print controller 52 outputs a print control signal via the I/F 54 to the printing apparatus 14, thereby energizing the printing apparatus 14 to print an image. The color value acquisition section 40 acquires color values of a designated color measured by the colorimeter 16, and stores the acquired color values in the memory 44. The color difference calculator 56 calculates a color difference between two colors.

The color information processor 42 serves to perform various color data processing processes, such as processes for mapping the color of a designated color outside of the range of the gamut to the gamut, and performing a color converting process. The color information processor 42 comprises a gamut inside/outside determining section 60, a mapping section 62, a color adjuster 64, a display color converter 66, an image data generator 68, a print color converter 70, and a profile generator 72. The color information processor 42 may be implemented through a processor, such as a DSP or the like.

The gamut inside/outside determining section 60 reads from the memory 44 the color values of a designated color measured by the colorimeter 16, and determines whether or not the color values of the designated color fall within the range of a color reproduction range (gamut) that can be printed by the printing apparatus 14, i.e., whether or not the designated color is a color that can be reproduced by the printing apparatus 14. The gamut varies with the type of printing apparatus 14. The user selects a printer profile of the printing apparatus 14 (printer) that is used, and based on the selected printer profile, the gamut inside/outside determining section 60 identifies the gamut of the printing apparatus 14.

The memory 44 stores printing profiles of a plurality of printing apparatus 14. The gamut inside/outside determining section 60 acquires the printer profile from the printing apparatus 14 that is connected to the color information processing apparatus 12, and identifies a gamut based on the acquired printer profile. If the gamut inside/outside determining section 60 judges that the acquired color values of the designated color do not fall within the range of the gamut, i.e., the acquired color values of the designated color are outside of the range of the gamut, then the gamut inside/outside determining section 60 outputs the acquired color values to the mapping section 62. If the acquired color values of the designated color fall within the range of the gamut, then the gamut inside/outside determining section 60 does not output the acquired color values to the mapping section 62.

The mapping section 62 maps color values of the designated color, which have been judged as falling outside of the range of the gamut by the gamut inside/outside determining section 60, to the range of the gamut. The mapping section 62 can map color values of the designated color, which have been judged as falling outside of the range of the gamut by the gamut inside/outside determining section 60, to the range of the gamut according to a plurality of mapping techniques. The mapping process according to such mapping techniques is carried out based on predetermined profiles corresponding to the mapping techniques. According to the present embodiment, mapping is carried out according to four respective mapping techniques, including, for example, a mapping technique based on impression matching, a mapping technique based on lightness matching, a mapping technique based on saturation matching, and a mapping technique based on minimum distance. The mapping section 62 includes a recording section in which multiple profiles are recorded corresponding to the respective mapping techniques.

In the mapping technique based on impression matching, mapping is performed by converting a designated color outside of the gamut and the gamut in a CIE CAM02 JCh space for minimizing color differences. The mapping technique based on impression matching is effective to convert colors suitably in a range from blue to magenta. The designated color mapped by the mapping technique based on impression matching is converted into color values in a color space represented by a CIEL*a*b* color system. The mapping technique based on lightness matching is a technique for mapping the color values of a designated color outside of the gamut to color values within the gamut, which match the lightness of the designated color outside the gamut, and which are spaced a minimum distance from the designated color outside the gamut. Color values in the gamut need not be spaced a minimum distance from the designated color outside the gamut, insofar as they match the lightness of the designated color outside the gamut. The mapping technique based on saturation matching is a technique for mapping the color values of a designated color outside of the gamut to color values within the gamut, which match the saturation of the designated color outside the gamut, and which are spaced a minimum distance from the designated color outside the gamut. Color values in the gamut need not be spaced a minimum distance from the designated color outside the gamut, insofar as they match the saturation of the designated color outside the gamut. The mapping technique based on minimum distance is a technique for mapping the color values of a designated color outside of the gamut to color values in the gamut, which are spaced a minimum distance from the designated color outside the gamut. The mapping section 62 stores the color values mapped by the above mapping techniques in the memory 44. The mapping section 62 is not limited to the aforementioned mapping technique based on impression matching, the mapping technique based on lightness matching, the mapping technique based on saturation matching, and the mapping technique based on minimum distance, but may also perform mapping using other mapping techniques known in the prior art.

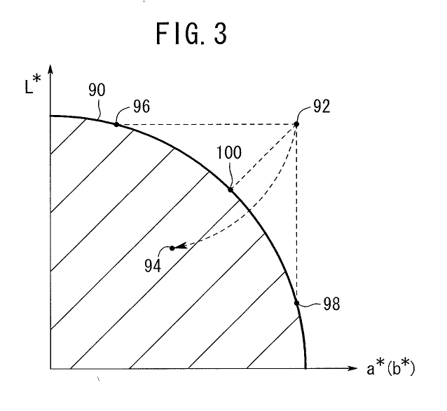

FIG. 3 is a diagram that illustrates the concept of a mapping process implemented by the mapping techniques of the present embodiment. In FIG. 3, a color space is shown as being two-dimensional for illustrative purposes. Since color values of a designated color in a color space represented by a CIEL*a*b* color system are acquired, the graph shown in the diagram of FIG. 3 has a vertical axis that represents L* and a horizontal axis that represents either a* or b*. The printing apparatus 14 has a gamut 90, which is shown by hatching in FIG. 3, based on the printer profile selected by the user. In FIG. 3, the point 92 represents the color values of a designated color, which is judged as lying outside of the range of the gamut 90. The point 94 represents color values, which are mapped by the mapping technique based on impression matching. The point 96 represents the color values, which are mapped by the mapping technique based on lightness matching. The point 98 represents the color values, which are mapped by the mapping technique based on saturation matching. The point 100 represents the color values, which are mapped by the mapping technique based on minimum distance.

The color adjuster 64 adjusts color values of a designated color mapped by the mapping section 62. The color adjuster 64 adjusts color values based on an input action to the adjustment operating section 74 made by the user. The color adjuster 64 may adjust color values mapped according to the mapping technique selected by the operating device 26. The color adjuster 64 stores in the memory 44 the adjusted color values that are determined by the user.

The display color converter 66 converts color values that are not dependent on devices into color values dependent on the display unit 24. For example, the display color converter 66 converts color values acquired by the colorimeter 16 and color values mapped by the mapping section 62 (e.g., color values in a color space represented by a CIEL*a*b* color system) into color values dependent on the display unit 24 (e.g., R, G, B color values).

The image data generator 68 generates image data of a color chart, including color patches having different lightness values and chromaticity values in a color space around given color values. The given color values may be measured color values of a designated color, the mapped color values of a designated color, or the adjusted color values of a designated color. Chromaticity values represent hue and saturation values. In other words, if a chromaticity value is changed, then either one of a hue value or a saturation value is changed. Since such color values are represented by values in a color space represented by a CIEL*a*b* color system, where L* represents lightness and a* and b* represent chromaticity, the image data generator 68 generates image data of a color chart, including a plurality of color patches having a plurality of color values with different L*, a*, b* values around the given color values. The image data generator 68 outputs the generated image data to the print color converter 70.

Alternatively, the image data generator 68 may generate image data of a color chart, including color patches having a plurality of color values with different light source color temperatures. Alternatively, the image data generator 68 may generate image data of a color chart, including color patches having a plurality of color values with different print medium materials.

The print color converter 70 converts image data of the color chart into color values dependent on the printing apparatus 14. More specifically, the print color converter 70 converts the image data of the color chart into C, M, Y, K color values.

The profile generator 72 corrects a profile corresponding to either one of the mapping techniques, to result in a profile that turns the designated color equal to a color selected by the user. When the designated color is mapped using the generated profile, the designated color is expressed by the color selected by the user.

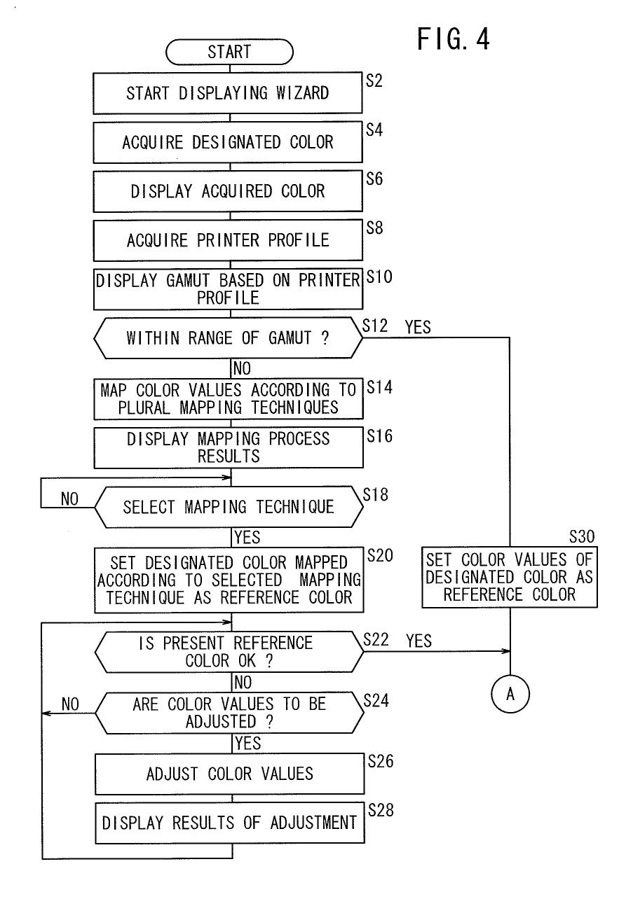

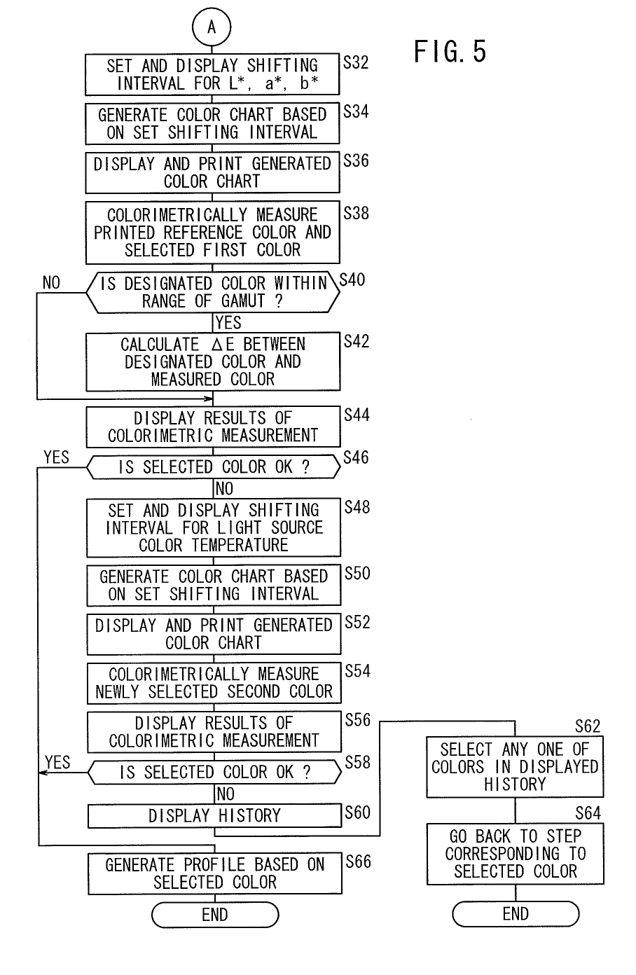

Operations of the print processing system 10 will be described below with reference to the flowcharts shown in FIGS. 4 and 5. First, the display controller 48 initiates display of a wizard for carrying out a plurality of steps of approximating or matching a color that actually is printed by the printing apparatus 14 to a designated color (step S2). These steps include the steps shown in FIGS. 4 through 6.

The color value acquisition section 40 acquires a designated color (step S4). More specifically, the color value acquisition section 40 acquires color values of a designated color measured by the colorimeter 16. The colorimeter 16 acquires color values that are device independent. In the illustrated embodiment, the colorimeter 16 acquires color values in a color space represented by a CIEL*a*b* color system. The display controller 48 displays a message such as “MEASURE COLOR SAMPLE OF A COLOR TO BE USED AS A DESIGNATED COLOR”, so as to prompt the user to measure color values. Based on the displayed message, the user uses the colorimeter 16 to measure color values, and the color information processing apparatus 12 acquires a designated color. The color value acquisition section 40 may acquire color values of a designated color from an external device. Alternatively, rather than from the color value acquisition section 40, the color information processing apparatus 12 may acquire color values that are entered by the user through the operating device 26 as a designated color.

The result display controller 80 displays the acquired color on the display unit 24 (step S6). In other words, the result display controller 80 displays the acquired designated color. When the acquired designated color is displayed, the user can confirm the color measured as the designated color on the screen of the display unit 24. Before the result display controller 80 displays the designated color, the display color converter 66 converts color values of the designated color into color values dependent on the display unit 24, and stores such converted color values in the memory 44. Then, the result display controller 80 displays a color based on the color values dependent on the display unit 24, which are stored in the memory 44. In the following description, it is assumed that if a color that is not dependent on the display unit 24 is to be displayed, then color values of the color are converted by the display color converter 66 into color values dependent on the display unit 24, and thereafter, the color is displayed based on the converted color values, although such a process will not be illustrated specifically.

Then, the gamut inside/outside determining section 60 acquires a printer profile selected by the user (step S8). The display controller 48 displays a message in order to prompt the user to select the printing apparatus 14, whereupon the user selects the printing apparatus 14 to be used based on the displayed message. The gamut inside/outside determining section 60 selects a printer profile corresponding to the selected printing apparatus 14. It is assumed that the memory 44 stores a printer profile therein that corresponds to the printing apparatus 14. Alternatively, the gamut inside/outside determining section 60 may acquire a printer profile of the printing apparatus 14 directly from the printing apparatus 14, which is connected to the color information processing apparatus 12.

Then, the gamut inside/outside determining section 60 identifies a gamut of the printing apparatus 14 based on the acquired printer profile, and the result display controller 80 displays the identified gamut (step S10). At this time, the result display controller 80 displays the gamut on coordinates of a color space represented by the same color system as the color values of the designated color, which is acquired by the color value acquisition section 40. Since in the illustrated embodiment, the color value acquisition section 40 acquires color values in a color space represented by a CIEL*a*b* color system, the result display controller 80 displays the gamut on coordinates of the color space represented by the CIEL*a*b* color system. The result display controller 80 may also display color values of the designated color on the coordinates.

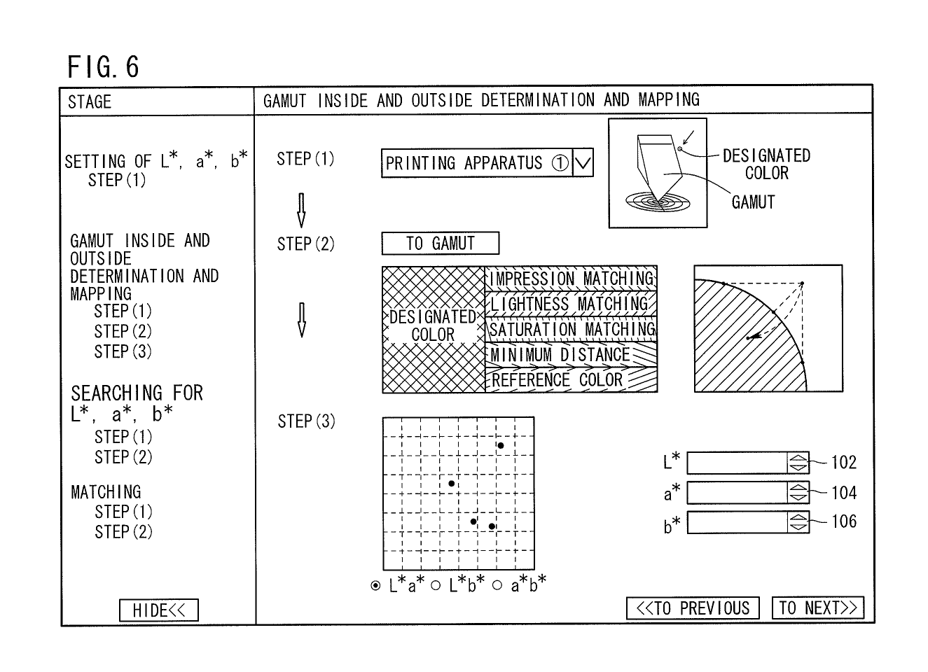

FIG. 6 is a view showing by way of example an image displayed by the result display controller 80. The image displayed by the result display controller 80 includes a left display region displaying four stages covering a plurality of steps of approximating or matching a color that actually is printed by the printing apparatus 14 to a designated color, the steps being divided into the four stages. The four stages represent setting of L*, a*, b* values, gamut inside and outside determination and mapping, searching for L*, a*, b* values, and matching. Each of the stages displays at least one step as a lower layer thereof. The user can operate the operating device 26 in order to press a button labeled “HIDE”, which is displayed below the stages and the steps, for hiding the stages and the steps. The steps shown in FIG. 6 and the steps of the flowcharts shown in FIGS. 4 and 5 are different from each other. The steps shown in FIG. 6 are sorted in order for the user to be able to recognize the steps with ease.

Step (1) for setting L*, a*, b* values corresponds to steps S4, S6 shown in FIG. 4. Step (1) for gamut inside and outside determination and mapping corresponds to steps S8, S10 shown in FIG. 4.

Since at present the steps pertaining to the stage of gamut inside and outside determination and mapping are carried out, a right display region of the image shown in FIG. 6 displays the results of the steps pertaining to the stage of gamut inside and outside determination and mapping. In the right display region, step (1), pertaining to the stage of gamut inside and outside determination and mapping, displays the gamut of the printing apparatus 14 selected by the user on coordinates of a given color space. Color values of the designated color also are displayed on coordinates of the color space where the gamut is displayed.

In FIG. 4, the gamut inside/outside determining section 60 determines whether or not the designated color falls within the range of the gamut (step S12). If the gamut inside/outside determining section 60 judges that the designated color falls outside of the range of the gamut, then the mapping section 62 maps the color values of the designated color acquired in step S4 to the range of the gamut (step S14). The mapped color values are stored in the memory 44. The mapping section 62 can map color values of the designated color to the range of the gamut according to a plurality of mapping techniques, which include a mapping technique based on impression matching, a mapping technique based on lightness matching, a mapping technique based on saturation matching, and a mapping technique based on minimum distance.

Then, the result display controller 80 displays the results of the mapping process on the display unit 24. More specifically, the result display controller 80 simultaneously displays the designated color and the mapped colors in positions adjacent to each other on the display unit 24. The result display controller 80 also displays the concept of the mapping techniques used when performing the mapping process (step S16).

In the right display region of the image shown in FIG. 6, step (2), pertaining to the stage of gamut inside and outside determination and mapping, simultaneously displays the designated color and the mapped colors in positions adjacent to each other, while also displaying the concept of the mapping techniques shown in FIG. 3 on the right side of the designated color and the mapped colors. A display area indicated by “DESIGNATED COLOR” displays the designated color. A display area indicated by “IMPRESSION MATCHING” displays the designated color mapped according to the mapping technique based on impression matching. A display area indicated by “LIGHTNESS MATCHING” displays the color mapped according to the mapping technique based on lightness matching. A display area indicated by “SATURATION MATCHING” displays the color mapped according to the mapping technique based on saturation matching. A display area indicated by “MINIMUM DISTANCE” displays the color mapped according to the mapping technique based on minimum distance.

The designated color and the designated colors mapped by the plural mapping techniques are displayed adjacent to each other. More specifically, the designated colors mapped by the mapping techniques are displayed in a downward sequence, indicated by “IMPRESSION MATCHING”, “LIGHTNESS MATCHING”, “SATURATION MATCHING”, and “MINIMUM DISTANCE”, on the left side of “DESIGNATED COLOR”, which is positioned adjacent thereto. Since the designated color and the mapped designated colors are displayed simultaneously, as well as being displayed adjacent to each other, the user is able to compare them easily. A display area indicated by “REFERENCE COLOR”, which is positioned below the display area indicated by “MINIMUM DISTANCE”, displays a reference color, to be described later.

In the right display region of the image shown in FIG. 6, step (3), pertaining to the stage of gamut inside and outside determination and mapping, displays coordinates associated with the mapped color values of the designated color, together with adjustment tool bars for adjusting the mapped color values. The user can recognize numerical values of the mapped color values of the designated color by observing the displayed coordinates. Symbols representative of coordinate axes for the displayed coordinates are displayed below the coordinates. More specifically, the symbols include “L*a*” indicating a vertical axis L* and a horizontal axis a*, “L*b*” indicating a vertical axis L* and a horizontal axis b*, and “a*b*” indicating a vertical axis a* and a horizontal axis b*. The user can select either one of the symbols using the keyboard 28 and the mouse 30 of the operating device 26. The display controller 48 displays the mapped color values in a dot position (point) according to the coordinate axis represented by the selected symbol. FIG. 6 shows coordinates of the color values when the symbol “L*a*” is selected. The display controller 48 may display the surface of the gamut in a two-dimensional pattern. The information displayed in step (3) is used particularly for color adjustment. The mapped color values indicated by dot positions may be displayed in different colors, depending on mapping techniques, so that the user can recognize which color value has been mapped according to which mapping technique.

After the results of the mapping process have been displayed in step S16, the controller 46 determines whether or not any one of the mapping techniques has been selected by the user (step S18). The user can select one of the mapping techniques by operating the operating device 26. The user may select one of the mapping techniques by selecting either one of the designated colors mapped by the mapping techniques displayed in step (2), pertaining to the stage of gamut inside and outside determination and mapping, using a mouse pointer or the like. For example, if the user selects the mapping technique based on saturation matching, then the user selects the designated color mapped according to the mapping technique based on saturation matching. Alternatively, the user may select one of the mapping techniques by selecting, with a mouse pointer or the like, either one of the color values indicated on the coordinates displayed in step (3), pertaining to the stage of gamut inside and outside determination and mapping. For example, if the user selects the mapping technique based on minimum distance, then the user selects the color values mapped according to the mapping technique based on minimum distance, which is indicated on the coordinates.

If the controller 46 judges that a mapping technique has not been selected by the user in step S18, then step S18 is repeated until a mapping technique is selected. If the controller 46 judges that a mapping technique has been selected by the user in step S18, then the controller 46 sets the color mapped by the selected mapping technique as a reference color (step S20). At this time, the result display controller 80 displays the set reference color in the display area indicated by “REFERENCE COLOR” in step (2), pertaining to the stage of gamut inside and outside determination and mapping. Color values of the designated color mapped by the mapping technique selected in step S18 are used as color values for the reference color. At this time, the user can differentiate between color values of the reference color displayed on the coordinates and other color values displayed on the coordinates. Step (2), pertaining to the stage of gamut inside and outside determination and mapping, corresponds to steps S12 through S20 and step S30 shown in FIG. 4.

Then, the controller 46 determines whether or not the present reference color is OK (step S22). In other words, the controller 46 determines whether it is acceptable to generate a color chart around the present reference color. If a button “TO NEXT” in the image shown in FIG. 6 is pressed, then the controller 46 judges that the present reference color is OK. When the button “TO NEXT” is pressed, the processing proceeds to a next stage, i.e., a stage of searching for L*, a*, b* values. Conversely, when a button “TO PREVIOUS” is pressed, the processing returns to the previous stage, i.e., the stage of setting the L*, a*, b* values.

If the controller 46 judges that the present reference color is unacceptable (not OK) in step S22, then the controller 46 determines whether or not color values of the present reference color should be adjusted (step S24). If the adjustment operating section 74 has adjusted the color values, then the controller 46 judges that the color values of the present reference color should also be adjusted.

If the controller 46 judges that color values of the present reference color are not to be adjusted in step S24, then control returns to step S22. If the controller 46 judges that the color values of the present reference color are to be adjusted in step S24, then the color adjuster 64 adjusts the color values of the present reference color, which is stored in the memory 44 (step S26). More specifically, the color adjuster 64 adjusts the color values of the present reference color according to an input action made by the user on the adjustment operating section 74. The adjusted color values serve as color values for the present reference color, and are stored in the memory 44.

The adjustment tool bars displayed in step (3), pertaining to the stage of gamut inside and outside determination and mapping shown in FIG. 6, are capable of adjusting the respective L*, a*, b* values. The user operates the adjustment operating section 74 so as to operate adjustment buttons 102, 104, 106 thereof, thereby directly entering values for L*, a* and b*. Accordingly, the user can adjust color values of the present reference color in order to bring them closer to the color values of the designated color, or to the color values of a desired color.

After the color adjuster 64 has adjusted the color values of the present reference color in step S26, the result display controller 80 displays the results of the adjustment (step S28), whereupon control then goes back to step S22. More specifically, the result display controller 80 changes the reference color in the display area indicated by “REFERENCE COLOR” to the adjusted reference color, and displays the adjusted reference color. The result display controller 80 also displays color values of the reference color on coordinates in terms of the adjusted color values. Step (3), pertaining to the stage of gamut inside and outside determination and mapping, corresponds to steps S22 through S28 shown in FIG. 4.

If the controller 46 judges that the present reference color is OK in step S22, then control proceeds to step S32 shown in FIG. 5. If the gamut inside/outside determining section 60 judges that the designated color falls within the range of the gamut in step S12, then the controller 46 sets the designated color acquired in step S4 as a reference color (step S30), at which point control proceeds to step S32 shown in FIG. 5. In this case, the result display controller 80 does not display step (2) and step (3), pertaining to the stage of gamut inside and outside determination and mapping shown in FIG. 6.

In step S32 shown in FIG. 5, the controller 46 sets a shifting interval for L*, a*, b* based on an input action made by the user on the operating device 26, and displays the set shifting interval. More specifically, the display controller 48 displays an image, which enables setting of a shifting interval for L*, a*, b* on the display unit 24, thereby allowing the user to specify a shifting interval for L*, a*, b* in the displayed image. The result display controller 80 displays the shifting interval that has been set by the user. Step (1), pertaining to searching for L*, a*, b* values, corresponds to step S32 shown in FIG. 5.

Then, the image data generator 68 generates image data of a color chart, including a plurality of color patches having values for L*, a*, b* that differ in terms of the set shifting interval, around the present reference color stored in the memory 44 (step S34). More specifically, the image data generator 68 generates image data of a color chart, including color patches arranged in a matrix.

Then, the result display controller 80 displays the generated color chart on the display unit 24, and the print controller 52 controls the printing apparatus 14 in order to print the color chart (step S36). More specifically, the result display controller 80 displays the color chart based on the generated image data, and the print controller 52 controls the printing apparatus 14 so as to print the color chart based on the generated image data. The print color converter 70 converts color values of the image data generated by the image data generator 68 into color values dependent on the printing apparatus 14, and stores the converted color values in the memory 44. The print controller 52 prints the color chart based on such converted image data. It shall be assumed in the following description that if an image is to be printed by the printing apparatus 14 based on image data, then the image data first are converted by the print color converter 70 into image data dependent on the printing apparatus 14, and thereafter, the image is printed based on the converted image data, although such a process will not be specifically illustrated.

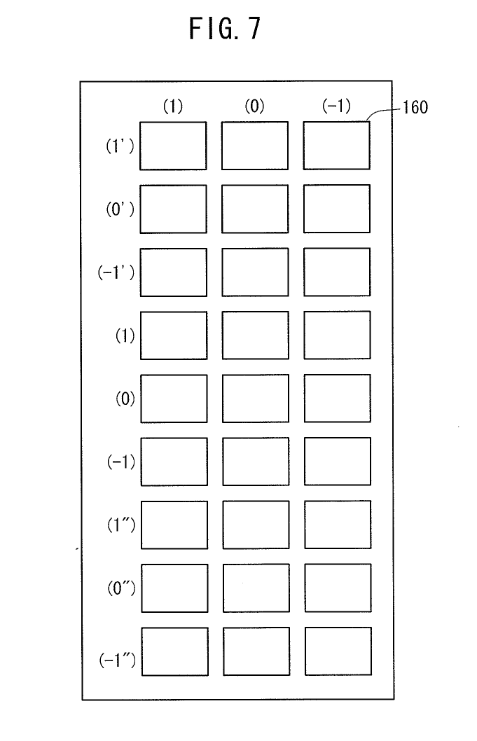

FIG. 7 shows by way of example a displayed and printed color chart. As shown in FIG. 7, the color chart has a plurality of color patches 160 marked with colors. The color patches 160 have respective different colors. The color patches 160 are arranged along rows and columns in a matrix, and are disposed at spaced intervals along the rows and columns. The color chart includes row numbers and column numbers for assisting the user in identifying positions of the color patches 160 along the rows and columns. A color patch identified by row number (0) and column number (0) represents the present reference color. A color patch identified by row number (0′) and column number (0), and a color patch identified by row number (0″) and column number (0) represent colors of color values, which are different from the value of L* of the present reference color, by certain intervals in positive and negative directions.

Nine color patches identified by row numbers (1), (0), (−1) represent colors of color values, which are different from the values of a* and b* of the color of the color patch identified by row number (0) and column number (0), by certain intervals in positive and negative directions. The color patches identified by row numbers (1) and (−1) have different values of a*, and the color patches identified by column numbers (1) and (−1) have different values of b*. Color patches identified by positive row and column numbers have different values in the positive direction, whereas color patches identified by negative row and column numbers have different values in the negative direction.

Nine color patches identified by row numbers (1′), (0′), (−1′) represent colors of color values, which are different from the values of a* and b* of the color of the color patch identified by row number (0′) and column number (0), by certain intervals in positive and negative directions. The color patches identified by row numbers (1′) and (−1′) have different values of a*, and the color patches identified by column numbers (1) and (−1) have different values of b*.

Nine color patches identified by row numbers (1″), (0″), (−1″) represent colors having color values that are different from the values of a* and b* of the color of the color patch identified by row number (0″) and column number (0), by certain intervals in positive and negative directions. The color patches identified by row numbers (1″) and (−1″) have different values of a*, and the color patches identified by column numbers (1) and (−1) have different values of b*.

Referring back to FIG. 5, after the color chart has been printed, from among the printed color patches, the colorimeter 16 measures the reference color and a selected first color (step S38). More specifically, the user moves the colorimeter 16 to the reference color and the selected first color, so as to measure the reference color and the selected first color. The selected first color refers to a color that the user believes to be closest to the designated color on the printed color chart. When the reference color actually is printed, the color looks different from the reference color on the displayed image, and hence differs from the designated color. The reference color and surrounding colors are actually printed, whereupon, from among such actually printed colors, the user selects a color that the user thinks is closest to the designated color. The selected color then is measured by the colorimeter 16. The color value acquisition section 40 stores color values of the measured reference color, together with color values of the selected and measured first color, in the memory 44.

Then, the controller 46 determines whether or not the designated color has been judged in step S12 as falling within the range of the gamut (step S40). If the controller 46 determines that the designated color has been judged in step S12 as falling within the range of the gamut (step S40), the color difference calculator 56 calculates a color difference ΔE₁ between the designated color and the measured reference color, and a color difference ΔE₂ between the designated color and the measured first color (step S42), after which control goes to step S44. If the controller 46 determines that the designated color has been judged in step S12 as falling outside of the range of the gamut in step S40, then control goes directly from step S40 to step S44.

In step S44, the result display controller 80 displays results of the colorimetric measurement. Specifically, the result display controller 80 simultaneously displays the measured reference color and the measured first color. The result display controller 80 may also display the designated color. Accordingly, the user finds it easy to visually compare the designated color and the printed reference color with each other, and also to visually compare the designated color and the first color with each other. The result display controller 80 also may display the color difference ΔE₁ between the designated color and the reference color, and the color difference ΔE₂ between the designated color and the first color. The color differences ΔE₁, AE₂ may be distinguished in the display, so that the user can visually recognize ΔE₁ as representing the color difference between the designated color and the reference color, and ΔE₂ as representing the color difference between the designated color and the first color. When the color differences ΔE₁, ΔE₂ are displayed, it is easy for the user to compare the designated color and the printed reference color with each other, and also to compare the designated color and the printed first color with each other, in terms of their numerical values. Step (2), pertaining to the stage of searching for L*, a*, b* values shown in FIG. 6, corresponds to steps S34 through S44 shown in FIG. 5.

The result display controller 80 displays the results of one stage in one image. For example, the result display controller 80 displays the results of steps (1), (2) of searching for L*, a*, b* values in one image, and displays the results of steps (1), (2) of matching in one image. Alternatively, the result display controller 80 is capable of displaying results of the steps in respective different images. For example, the result display controller 80 may display the results of step (1), the results of step (2), and the results of step (3), respectively, in different images.

Then, the controller 46 determines whether the designated color can be expressed by the first color selected in step S38 depending on an input action made by the user on the operating device 26 (step S46). If the controller 46 judges that the selected color is unacceptable (not OK) in step S46, then the controller 46 sets a shifting interval for the color temperature of the light source, depending on an input action made by the user on the operating device 26, and displays the set shifting interval. More specifically, the display controller 48 controls the display unit 24 in order to display an image for setting a shifting interval for the color temperature of the light source, thereby allowing the user to set a shifting interval for the color temperature of the light source in the displayed image. The result display controller 80 displays the shifting interval that has been set. Step (1), pertaining to the matching stage, corresponds to step S48 shown in FIG. 5.

Then, the image data generator 68 generates anew image data of a color chart, including a plurality of color patches having different color temperatures of light sources, which differ in terms of their set shifting interval, around the selected color measured in step S38, which is used as a color under a light source having a reference color temperature (step S50). The reference color temperature is 5000 K (D50), for example.

Then, the result display controller 80 controls the display unit 24 in order to display the newly generated color chart, whereas the print controller 52 controls the printing apparatus 14 in order to print the newly generated color chart (step S52). More specifically, the result display controller 80 controls the display unit 24 in order to display the color chart based on the generated image data, whereas the print controller 52 controls the printing apparatus 14 in order to print the color chart based on the generated image data.

After the color chart has been printed, the colorimeter 16 measures a selected second color from among the printed color patches (step S54). The selected second color refers to a color that the user believes to be closest to the designated color on the newly printed color chart.

Then, the result display controller 80 displays results of the colorimetric measurement. More specifically, the result display controller 80 displays the measured second color (step S56). The color difference calculator 56 can calculate the color difference ΔE₃ between the designated color and the measured second color, and the result display controller 80 can simultaneously display the calculated color difference ΔE₃. The result display controller 80 may also simultaneously display the designated color. Step (2), pertaining to the matching stage, corresponds to steps S50 through S56 shown in FIG. 5.

Then, the controller 46 determines whether the designated color is capable of being expressed by the second color selected in step S54, depending on an input action made by the user on the operating device 26 (step S58). If the controller 46 judges that the selected color is unacceptable (not OK) in step S58, then the controller 46 displays a plurality of colors, which were acquired in a plurality of steps, as a history of changing designated colors (step S60). More specifically, the color history display controller 82 displays the mapped designated color, which was set as the reference color in step S20, the latest reference color that was adjusted in step S26, the reference color and the first color that were measured in step S38, and the second color that was measured in step S54, as a history of changing designated colors.

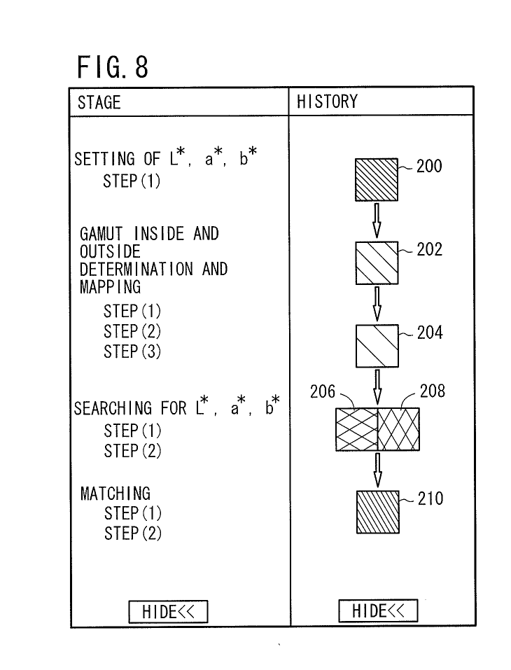

FIG. 8 is a diagram showing a displayed image representing a displayed history of changing designated colors. The displayed image includes a left display region displaying four stages covering a plurality of steps of approximating or matching a color that actually is printed by the printing apparatus 14 to a designated color, wherein the steps are divided into the four stages. Each of the stages displays at least one step as a lower layer thereof.

The displayed image includes a right display region in which a history of changing designated colors is displayed. More specifically, the history of changing designated colors includes displayed colors that have been acquired in the respective stages. The colors acquired in the respective stages are displayed on the right side of the stages. More specifically, the designated color acquired in step S4 is displayed in a frame 200, which corresponds to the stage of setting L*, a*, b* values. Frames 202, 204 correspond to the stage of gamut inside and outside determination and mapping. If the designated color falls outside of the gamut, then the designated color mapped by the selected mapping technique, i.e., the reference color set in step S20, is displayed in frame 202. If the designated color falls within the gamut, then the designated color, i.e., the reference color set in step S30, is displayed in frame 202. If the designated color falls outside of the gamut, then the last adjusted reference color, i.e., the present reference color that was judged as being OK in step S22, is displayed in frame 204. If the designated color falls within the gamut, then no color may be displayed in the frame 204.

Frames 206 and 208 correspond to the stage of searching for L*, a*, b* values. The reference color measured in step S38 is displayed in the frame 206, i.e., the color displayed in the frame 204, which actually is printed, is displayed in the frame 206. The first color measured in step S38 is displayed in the frame 208. The second color measured in step S54 is displayed in a frame 210, which corresponds to the matching stage. The color difference ΔE₁ between the designated color and the measured reference color (the color difference between the color displayed in the frame 200 and the color displayed in the frame 206), and the color difference ΔE₂ between the designated color and the measured first color (the color difference between the color displayed in the frame 200 and the color displayed in the frame 208), which are calculated in step S42, may be displayed.

Since colors acquired in the above steps are displayed as a history of changing designated colors, the user can easily recognize how the designated color has been changed, so as to bring the color that actually is printed close to the designated color. The color history display controller 82 may display color values of the colors that are displayed in respective frames. The color history display controller 82 may also display a numerical value representing a difference between a color displayed in a given frame and a color displayed in at least one frame other than the given frame. The given frame may be a predetermined frame, or may be a frame that is selected by the user. The given frame is distinguished from the other frames. For example, the given frame may be displayed as a thick frame, or may be accompanied by a mark displayed therewith.

Then, depending on an input action made by the user on the operating device 26, the controller 46 selects any one of the colors displayed in the history of changing designated colors (step S62). More specifically, the user operates the selector 76 of the operating device 26 to specify any one of the frames 200, 202, 204, 206, 208 or 210 with a mouse pointer or the like, for thereby selecting one of the colors.

Then, control returns to the step that corresponds to the selected color (step S64), i.e., to the step that is capable of changing the selected color. Control may go back to the stage that is capable of changing the selected color. For example, if the frame 200 is selected, then control goes back to step (1), pertaining to the stage of setting L*, a*, b* values, to acquire a new designated color. If the frame 202 is selected, provided that the designated color falls outside of the gamut, then control goes back to steps (1), (2), pertaining to the stage of gamut inside and outside determination and mapping, in order to select anew a printer profile and a mapping technique. In other words, control goes back to step S8 or step S18.

If the frame 204 is selected, provided that the designated color falls outside the gamut, then control goes back to step (3), pertaining to the stage of gamut inside and outside determination and mapping, in order to readjust the reference color. In other words, control goes back to step S24. If the designated color falls within the gamut, then the frames 202, 204 may not be specified. If the frames 202, 204 are specified, provided that the designated color falls within the gamut, then control may go back to step (1), pertaining to the stage of setting the L*, a*, b* values.

If the frame 206 or 208 is selected, then control may go back to steps (1), (2), pertaining to the stage of searching for L*, a*, b* values, to set a shifting interval and remeasure a color to be newly selected. In other words, control goes back to step S32 or S38. If the frame 210 is selected, then control may go back to steps (1), (2), pertaining to the matching stage, to set a shifting interval and remeasure a color to be newly selected. In other words, control goes back to step S48 or S54. When control goes back to a step corresponding to a selected color, the above sequence is carried out again from the step to which control has gone back.

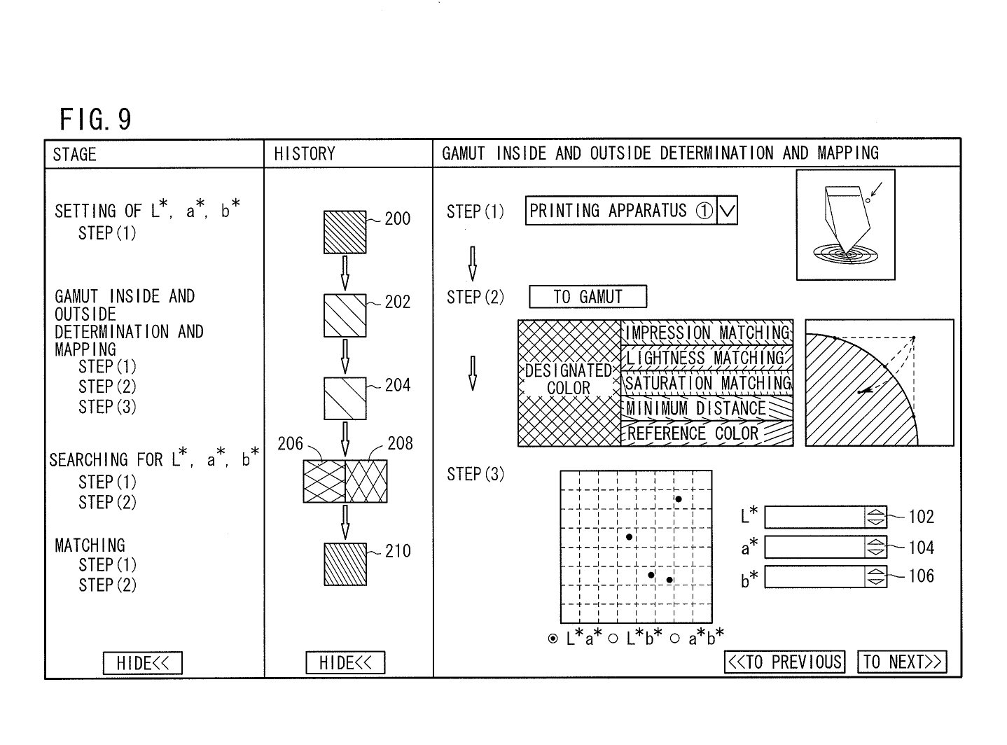

FIG. 9 is a view showing an image, which is displayed when control goes back to steps corresponding to selected colors, when the frame 202 or 204 shown in FIG. 8 is selected. Since the frames 202, 204 belong to the stage of gamut inside and outside determination and mapping, the stage of gamut inside and outside determination and mapping can be carried out again. As shown in FIG. 9, the displayed image includes a right display region that displays the stages and steps, a central display region that displays the history of changing designated colors, and a right display region that displays the results of gamut inside and outside determination and mapping. The result display controller 80 displays results produced when new steps are executed, and the color history display controller 82 displays newly obtained colors in the history of changing designated colors. The user can operate the operating device 26 to press a button “HIDE”, which is displayed below the history of changing designated colors, in order to hide the history of changing designated colors.

The color history display controller 82 displays the history of changing designated colors after the selected color has been judged as being unacceptable (not OK) in step S58. However, the color history display controller 82 may display a history of changing designated colors each time that a step is carried out, so that control can return to an executed step at any time according to the user's instructions. In this case, the color history display controller 82 displays, as a history of changing designated colors, colors acquired in steps that have already been carried out.

If the selected color is judged as being OK in step S46 or S58, then a profile corresponding to the last mapping technique selected in step S18 is corrected in order to generate a profile for converting the designated color acquired in step S4 into the color that has been judged to be OK (step S66). By mapping a color utilizing such a generated profile, the color can be printed exactly or as closely to the designated color as possible.

Since the result produced when each of the steps is carried out is displayed each time that the step is carried out, the user can confirm the result of each step. Further, since a plurality of colors, which are acquired by a plurality of steps, are displayed as a history of changing designated colors, the user can recognize how the colors have been changed, and also can recognize any step to be carried out again, by viewing the history of changing designated colors. When either one of the colors in the displayed history is selected, control goes back to the step that is capable of changing the selected color. Therefore, any one of the steps can be carried out again simply and appropriately, for thereby approximating or matching the color to be printed by the printing apparatus 14 to the designated color.

In order to allow the user to recognize how colors have changed and how the colors are matched, when control goes back to a step that has been executed, the history of changing designated colors before control goes back to the step may be stored. Thereafter, the history of changing designated colors before control goes back to the step, and the history of changing designated colors after control goes back to the step may be displayed simultaneously. Specifically, the history of changing designated colors before control goes back to the step may be displayed as a first history, and thereafter, the history of changing designated colors after control goes back to the step may be displayed as a second history. If control subsequently goes back to another step which has already been executed, then the history of changing designated colors after control goes back to the other step may be displayed as a third history.

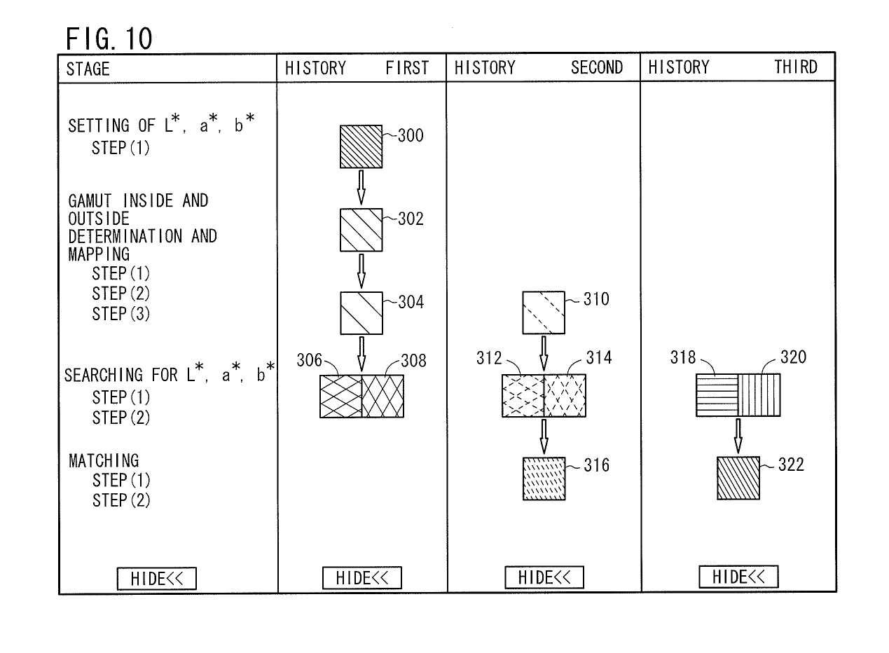

FIG. 10 is a diagram showing a displayed image, representing a displayed history of changing designated colors. As shown in FIG. 10, after a reference color and a first color, which have been measured and printed, are obtained, the user selects a frame 304, and control goes back to step (3), pertaining to the stage of gamut inside and outside determination and mapping. The history up to the selection of frame 304 is displayed as a first history. A color, which is obtained after the frame 304 is selected and control goes back to step (3) pertaining to the stage of gamut inside and outside determination and mapping, is displayed as a second history. In the second history, a frame 312 or a frame 314 is selected, and control goes back to step (1) or step (2), pertaining to the stage of searching for L*, a*, b* values. The history up to the selection of frame 312 or 314 is displayed as the second history. A color, which is obtained after frame 312 or 314 is selected and control goes back to step (1) or (2) pertaining to the stage of searching for L*, a*, b* values, is displayed as a third history. Consequently, even when control goes back to a step that has been carried out, the history of changing designated colors before control goes back to the step is saved and displayed. The user is thus able to visually recognize quickly how the colors are matched. Although not shown in FIG. 10, the results of the steps of the stages shown in FIG. 9 may be displayed in an image display region on the right side of the displayed history of changing designated colors.

Although certain preferred embodiments of the present invention have been shown and described in detail, it should be understood that various changes and modifications may be made to the embodiments without departing from the scope of the invention as set forth in the appended claims.

What is claimed is:

1. A color information processing apparatus comprising:
a color information processor for carrying out a plurality of steps for approximating or matching a color that actually is printed by a printing apparatus to a designated color;
a result display controller for displaying a result of each of the steps each time that the steps are carried out; and
a color history display controller for displaying a plurality of colors acquired in the steps as a history of changing designated colors.

2. A color information processing apparatus according to claim 1, further comprising:
a selector for a user to select one of the colors displayed by the color history display controller,
wherein, when the user selects one of the colors through the selector, the color information processor goes back to one of the steps which can change the selected color, and carries out again the steps from the one of the steps.

3. A color information processing apparatus according to claim 1, wherein the steps carried out by the color information processor include:
a step of acquiring the designated color;
a step of, if the designated color falls outside of a range of a gamut of the printing apparatus, mapping the designated color to the range of the gamut in order to acquire the designated color;
a step of generating image data of a first color chart including a plurality of color patches having different lightness values and chromaticity values within a color space around a reference color, the mapped designated color being set as the reference color if the designated color falls outside of the range of the gamut, and the designated color being set as the reference color if the designated color falls within the range of the gamut; and
a step of colorimetrically measuring the first color chart, which is printed by the printing apparatus based on the image data, thereby acquiring the reference color that is printed together with a first color selected by a user,
wherein the color history display controller displays as the history of changing designated colors the designated color, the reference color, the reference color that is measured colorimetrically, and the first color.

4. A color information processing apparatus according to claim 3, further comprising:
a color difference calculator for calculating a color difference between a given color and at least one color other than the given color, among the colors displayed by the color history display controller,
wherein the color history display controller displays the color difference calculated by the color difference calculator.

5. A color information processing apparatus according to claim 4, wherein:
the color difference calculator calculates a color difference between the designated color and the reference color that is printed, and a color difference between the designated color and the first color if the designated color falls within the range of the gamut; and
the color history display controller displays the color difference between the designated color and the reference color that is printed, and the color difference between the designated color and the first color.

6. A color information processing apparatus according to claim 3, wherein:
the step of mapping the designated color to the range of the gamut in order to acquire the designated color acquires a plurality of designated colors by mapping the designated color to the range of the gamut according to a plurality of mapping techniques; and
the step of generating image data of a first color chart generates image data of a first color chart including a plurality of color patches having different lightness values and chromaticity values within a color space around a reference color, wherein the designated color that is mapped according to one of the mapping techniques, which is selected by the user, is set as the reference color.

7. A color information processing apparatus according to claim 6, wherein, as a result of the step of mapping the designated color to the range of the gamut, the result display controller simultaneously displays the designated colors mapped according to the mapping techniques and the acquired designated colors in adjacent positions.

8. A color information processing apparatus according to claim 6, wherein, as a result of the step of mapping the designated color to the range of the gamut, the result display controller displays color values of the designated colors mapped according to the mapping techniques on coordinates.

9. A color information processing apparatus according to claim 3, wherein the steps carried out by the color information processor further include:
a step of adjusting the mapped designated color that is set as the reference color,
wherein the step of generating image data of a first color chart generates image data of a first color chart including a plurality of color patches having different lightness values and chromaticity values within a color space around the reference color, which is adjusted if the designated color falls outside of the range of the gamut, and
wherein the color history display controller displays the reference color that is adjusted.

10. A color information processing apparatus according to claim 3, wherein the steps carried out by the color information processor further include:
a step of generating image data of a second color chart including the color patches at different color temperatures of light sources around the first color as a color under a light source having a reference color temperature; and
a step of acquiring a second color selected by the user by colorimetrically measuring the second color chart that is printed by the printing apparatus based on the image data,
wherein the color history display controller displays the second color.

11. A recording medium storing a program for enabling a computer to function as:
a color information processor for carrying out a plurality of steps for approximating or matching a color that actually is printed by a printing apparatus to a designated color;
a result display controller for displaying a result of each of the steps each time that the steps are carried out; and
a color history display controller for displaying a plurality of colors acquired in the steps as a history of changing designated colors.
